(19) United States
(12) Patent Application Publication
(10) Pub. No.: US 2026/0246941 A1
(43) Pub. Date: Aug. 20, 2026

(54) DECODING METHOD, ENCODING METHOD, AND DECODING DEVICE

(71) Applicant: Panasonic Intellectual Property Corporation of America, Torrance, CA (US)

(72) Inventors: Masato Ohkawa, Toyama (JP); Noritaka Iguchi, Osaka (JP); Toshiyasu Sugio, Osaka (JP); Takahiro Nishi, Nara (JP); Atsushi Ito, Osaka (JP)

(21) Appl. No.: 19/640,946

(22) Filed: Apr. 7, 2026

Related U.S. Application Data
(63) Continuation of application No. PCT/JP2024/033246, filed on Sep. 18, 2024.
(60) Provisional application No. 63/544,016, filed on Oct. 13, 2023.

(51) Int. Cl. H04N 19/13; G06T 9/00; H04N 19/17; H04N 19/91

(52) U.S. Cl. CPC H04N 19/13; G06T 9/001; H04N 19/17; H04N 19/91

(57) ABSTRACT

A decoding method includes: generating a coefficient by arithmetic-decoding an encoded coefficient using contexts; and generating attribute information of a three-dimensional point by inverse-binarizing and inverse-quantizing the coefficient, in which a total number of the contexts is set according to a level specified by a standard.

### CROSS REFERENCE TO RELATED APPLICATIONS

This is a continuation application of PCT International Application No. PCT/JP2024/033246 filed on Sep. 18, 2024, designating the United States of America, which is based on and claims priority of U.S. Provisional Patent Application No. 63/544,016 filed on Oct. 13, 2023. The entire disclosures of the above-identified applications, including the specifications, drawings and claims are incorporated herein by reference in their entirety.

### FIELD

The present disclosure relates to a decoding method, an encoding method, a decoding device, and an encoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

International Publication WO 2014/020663

### SUMMARY

### Technical Problem

In such encoding and decoding of three-dimensional data, there is a demand for improving encoding efficiency.

The present disclosure provides a decoding method, an encoding method, a decoding device, or an encoding device capable of improving encoding efficiency.

### Solution to Problem

A decoding method according to one aspect of the present disclosure includes: generating a coefficient by arithmetic-decoding an encoded coefficient using contexts; and generating attribute information of a three-dimensional point by inverse-binarizing and inverse-quantizing the coefficient, in which a total number of the contexts is set according to a level specified by a standard.

An encoding method according to one aspect of the present disclosure includes: generating a coefficient by quantizing and binarizing attribute information of a three-dimensional point; and arithmetic-encoding the coefficient using contexts, in which a total number of the contexts is set according to a level specified by a standard.

### Advantageous Effects

The present disclosure can provide a decoding method, an encoding method, a decoding device, or an encoding device capable of improving encoding efficiency.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of an encoding device according to a present embodiment.

FIG. 2 is a block diagram of a decoding device according to the present embodiment.

FIG. 3 is a block diagram of an attribute decoder according to the present embodiment.

FIG. 4 is a diagram illustrating an example of a quantization table according to the present embodiment.

FIG. 5 is a block diagram of an attribute encoder according to the present embodiment.

FIG. 6 is a diagram illustrating a correspondence between an output of a quantization table of the decoding device and an output of a quantization table of the encoding device according to the present embodiment.

FIG. 7 is a block diagram illustrating the configuration of a processing unit related to a quantization process according to the present embodiment.

FIG. 8 is a flowchart of a decoding process according to the present embodiment.

FIG. 9 is a block diagram of the decoding device according to the present embodiment.

FIG. 10 is a flowchart of an encoding process according to the present embodiment.

FIG. 11 is a block diagram of the encoding device according to the present embodiment.

### DESCRIPTION OF EMBODIMENT

A decoding method according to one aspect of the present disclosure includes: generating a coefficient by arithmetic-decoding an encoded coefficient using contexts; and generating attribute information of a three-dimensional point by inverse-binarizing and inverse-quantizing the coefficient, in which a total number of the contexts is set according to a level specified by a standard.

In this manner, an encoding device can appropriately set the number of contexts in arithmetic encoding according to the level specified by the standard. Accordingly, the encoding device can improve encoding efficiency. Moreover, the decoding method can appropriately decode the bitstream whose encoding efficiency has been improved in this manner.

For example, the total number of the contexts may be 3 when the level is a first level, and the total number of the contexts may be a value in a range of 4 to 12 inclusive when the level is a second level. With this, encoding efficiency in arithmetic encoding in the encoding device can be improved.

For example, the total number of the contexts may be 12 when the level is the second level. With this, encoding efficiency in arithmetic encoding in the encoding device can be improved.

An encoding method according to one aspect of the present disclosure includes: generating a coefficient by quantizing and binarizing attribute information of a three-dimensional point; and arithmetic-encoding the coefficient using contexts, in which a total number of the contexts is set according to a level specified by a standard.

In this manner, the encoding method can appropriately set the number of contexts in arithmetic encoding according to the level specified by the standard. Accordingly, the encoding method can improve encoding efficiency.

A decoding device according to one aspect of the present disclosure includes a processor and memory. Using the memory, the processor: generates a coefficient by arithmetic-decoding an encoded coefficient using contexts; and generates attribute information of a three-dimensional point by inverse-binarizing and inverse-quantizing the coefficient, and a total number of the contexts is set according to a level specified by a standard.

An encoding device according to one aspect of the present disclosure includes a processor and memory. Using the memory, the processor: generates a coefficient by quantizing and binarizing attribute information of a three-dimensional point; and arithmetic-encodes the coefficient using contexts. A total number of the contexts is set according to a level specified by a standard.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, an embodiment will be specifically described with reference to the drawings. It is to be noted that the following embodiment indicates a specific example of the present disclosure. The numerical values, shapes, materials, constituent elements, the arrangement and connection of the constituent elements, steps, the processing order of the steps, etc., indicated in the following embodiment are mere examples, and thus are not intended to limit the present disclosure. Among the constituent elements described in the following embodiment, constituent elements not recited in any one of the independent claims will be described as optional constituent elements.

### Embodiment

### Overview of Quantization and Inverse Quantization of Attribute Information

Hereinafter, an encoding device (three-dimensional data encoding device) and a decoding device (three-dimensional data decoding device) according to the present embodiment will be described. The encoding device generates a bitstream by encoding three-dimensional data. The decoding device generates three-dimensional data by decoding the bitstream.

The three-dimensional data is, for example, three-dimensional point cloud data (also referred to as point cloud data). A point cloud is a set of three-dimensional points, and represents the three-dimensional shape of an object. The point cloud data includes position information and attribute information of the three-dimensional points. The position information indicates the three-dimensional position of each three-dimensional point. It should be noted that the position information may also be referred to as geometry information. For example, the position information is represented using an orthogonal coordinate system or a polar coordinate system.

The attribute information indicates, for example, color information, reflectance, transmittance, infrared information, a normal vector, or time information. One three-dimensional point may have a single item of attribute information or have a plurality of types of attribute information.

It should be noted that although mainly encoding and decoding of attribute information will be described below, the encoding device and the decoding device may perform encoding and decoding of position information.

Moreover, as a point cloud compression standard, a geometry-based point cloud compression (G-PCC) standard using position information (geometry information) is known. In G-PCC, as encoding schemes for attribute information, there are a level-of-detail (LoD) scheme (e.g., a Lifting scheme) and a transform scheme (e.g., a region adaptive hierarchical transform (RAHT) scheme). The encoding device can select and use these encoding schemes.

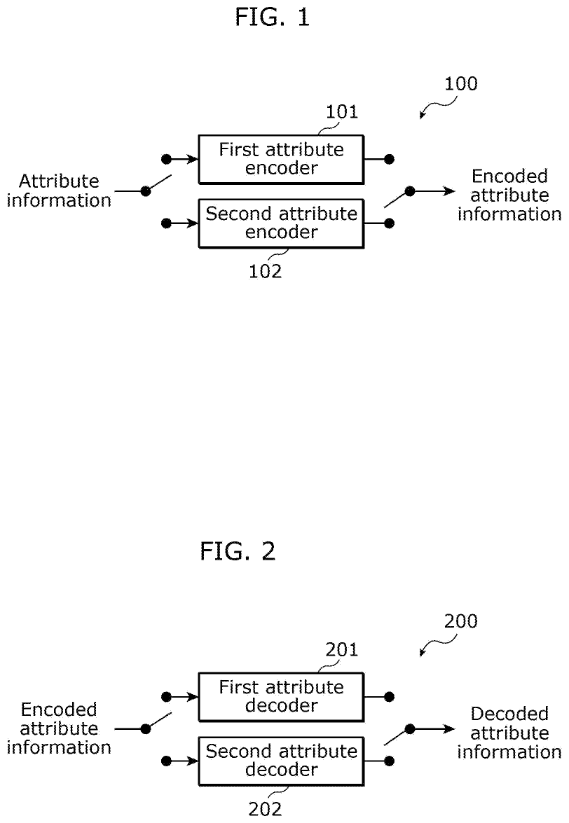

FIG. 1 is a block diagram of encoding device 100 according to the present embodiment. It should be noted that in FIG. 1, only processing units related to encoding of attribute information are illustrated. Encoding device 100 includes first attribute encoder 101 and second attribute encoder 102. First attribute encoder 101 generates encoded attribute information by encoding attribute information using a first encoding scheme (e.g., the LoD scheme). Second attribute encoder 102 generates encoded attribute information by encoding attribute information using a second encoding scheme (e.g., the transform scheme) different from the first encoding scheme.

FIG. 2 is a block diagram of decoding device 200 according to the present embodiment. It should be noted that in FIG. 2, only processing units related to decoding of attribute information are illustrated. Decoding device 200 includes first attribute decoder 201 and second attribute decoder 202. First attribute decoder 201 generates decoded attribute information by decoding the encoded attribute information using a first decoding scheme (e.g., the LoD scheme). Second attribute decoder 202 generates decoded attribute information by decoding the encoded attribute information using a second decoding scheme (e.g., the transform scheme) different from the first decoding scheme.

In both schemes, the encoding device generates an encoding coefficient by transforming the input attribute information using a predetermined scheme, and generates a quantized encoding coefficient by quantizing the encoding coefficient. Furthermore, the encoding device generates encoded data by entropy-encoding the quantized encoding coefficient.

It should be noted that in the present embodiment, the encoding coefficient is referred to as data, and the quantized encoding coefficient is referred to as quantized data. In quantizing data in the encoding device, a QP value (e.g., 4 to 95), which is an integer value in a predetermined range, is used, and based on the QP value, a scale value for use in quantization (in some cases, also referred to as a quantization width (Qstep)) is derived using a predetermined method.

Next, the encoding device generates quantized data by quantizing the data using the scale value. For example, as shown in (Equation 1) below, the scale value is calculated by inputting the QP value into a predetermined transform function. Moreover, as shown in (Equation 2), the quantized data is generated by dividing the data by the scale value.

$$Scale value = transform function ( QP value ) \qquad ( Equation 1 )$$

$$Quantized data = data / scale value \qquad ( Equation 2 )$$

Here, the QP value used for quantization in the encoding device is stored in metadata such as an attribute parameter set (APS) and is notified to the decoding device. APS is control information included in a bitstream (also referred to as a parameter set or metadata), and is also control information related to encoding of attribute information. For example, APS is control information common to a plurality of frames. Moreover, the encoded data obtained by entropy-encoding is stored and transmitted in an attribute data unit.

The decoding device obtains the QP value by decoding the APS, and transforms the QP value to a scale value using a predetermined method. Next, the decoding device inverse-quantizes the separately decoded quantized data using the scale value. For example, as shown in (Equation 3) below, the scale value is calculated by inputting the QP value into a predetermined transform function. Moreover, as shown in (Equation 4), data is generated by multiplying the quantized data by the scale value.

$$Scale value = transform function ( QP value ) \qquad ( Equation 3 )$$

$$Data = quantized data \times scale value \qquad ( Equation 4 )$$

### Inverse Quantization Process in Decoding Device

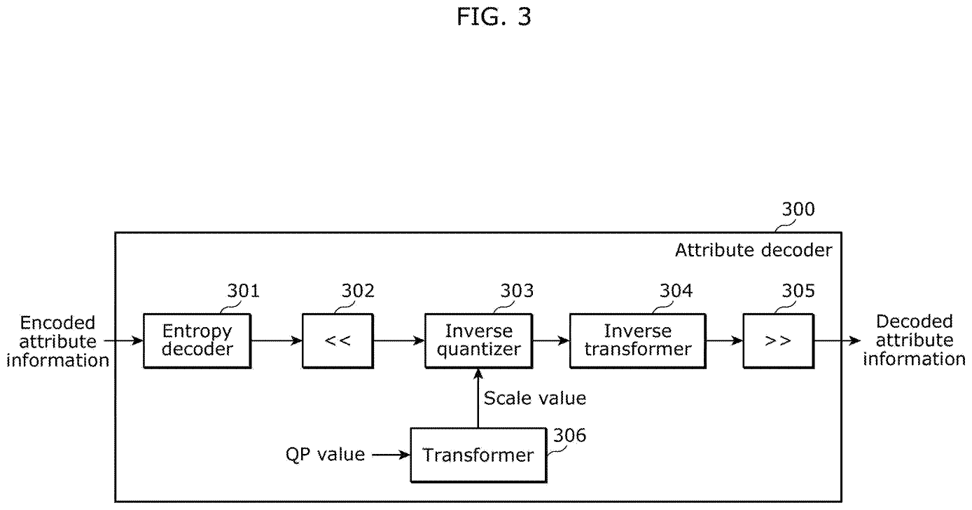

Hereinafter, an inverse quantization process in the decoding device will be described. FIG. 3 is a block diagram of attribute decoder 300 included in the decoding device. For example, attribute decoder 300 corresponds to first attribute decoder 201 or second attribute decoder 202 illustrated in FIG. 2. Attribute decoder 300 includes entropy decoder 301, left bit shifter 302, inverse quantizer 303, inverse transformer 304, right bit shifter 305, and transformer 306.

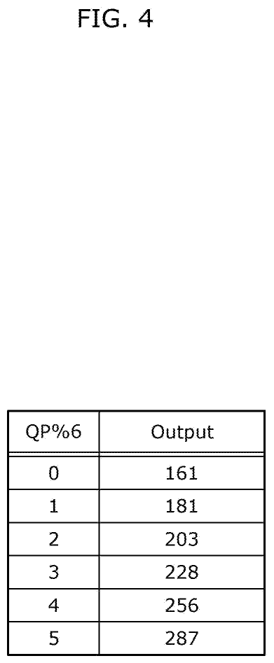

The decoding device obtains the QP value from the APS. Transformer 306 transforms the remainder of the QP value divided by 6 using a quantization table (QP table). FIG. 4 is a diagram illustrating an example of the quantization table. As illustrated in FIG. 4, the quantization table indicates the relationship between the remainder of the QP value divided by 6 (QP % 6) and the output. Transformer 306 derives the product of the scale value and 2⁸ (left-shifted scale value) by multiplying the transformed value (output of the quantization table) by 2^{(QP/6)}.

Entropy decoder 301 generates quantized data by entropy-decoding the encoded attribute information included in the bitstream. For example, entropy decoder 301 generates binary data by arithmetic-decoding the encoded attribute information using contexts, and generates quantized data by inverse-binarizing (de-binarizing) the binary data.

Left bit shifter 302 generates left-shifted quantized data by shifting the quantized data to the left. Inverse quantizer 303 generates left-shifted data by inverse-quantizing the left-shifted quantized data using the scale value (left-shifted scale value). Inverse transformer 304 generates left-shifted decoded attribute information by inverse-transforming the left-shifted data. In other words, inverse transformer 304 performs decoding using the LoD scheme or the RAHT scheme. Right bit shifter 305 generates decoded attribute information by shifting the left-shifted decoded attribute information to the right.

In this way, the decoding device uses the quantization table and shifts bits to the left (performs multiplication by a power of 2 or left shift operation). Furthermore, the decoding device shifts bits to the right (performs division by a power of 2 or right shift operation). This improves the calculation accuracy of lower bits in fixed-point operations and makes it possible to avoid using floating-point operations or division in inverse quantization. For example, by combining transform using a table and shift-down, multiplication by 1 or less in inverse quantization can be implemented without using floating-point operations. When data is inverse-quantized using a parameter having a precision of 1 or less, by performing the inverse quantization after data is shifted to the left and shifting the inverse-quantized data to the right, the accuracy of multiplication having a precision of 1 or less can be improved.

Here, the scale value output from transformer 306 (left-shifted scale value) is represented by (scale value<<8) as shown in (Equation 5) below, and is obtained by multiplying the output of the quantization table (QPtable (QP % 6)) by 2^{(QP/6)}. Moreover, the data, the quantized data, and the scale value are represented by (Equation 6) below.

$$( Scale value ≪ 8 ) = QPtable ( QP \% 6 ) ≪ ( QP / 6 ) \qquad ( Equation 5 )$$

$$Data = \{ quantized data \times ( scale value ≪ 8 ) \} ≫ 8 \qquad ( Equation 6 )$$

In other words, the data, the quantized data, and the scale value are represented by (Equation 7) below.

$$Data = \{ quantized data \times ( scale value \times left - shift parameter ) \} / left - shift parameter \qquad ( Equation 7 )$$

In other words, the quantization table is a table for deriving a scale value shifted to the left using a left-shift parameter for bits (scale value×left-shift parameter). By inverse-quantizing the quantized data using the left-shifted scale value, the left-shifted data is reconstructed.

It should be noted that the scale value is shifted to the left during the process of calculation using the quantization table in transformer 306. The left-shifted data is output from inverse quantizer 303 and inverse-transformed in inverse transformer 304. Accordingly, right shift is performed in right bit shifter 305 since the output data of inverse transformer 304 is left-shifted data.

It should be noted that left bit shifter 302 multiplies the quantized data by the left-shift parameter as the left shift. Right bit shifter 305 divides the quantized data by a left-shift parameter as the right shift. The left shift included in the transform using the quantization table corresponds to multiplying the scale value by the left-shift parameter.

As described above, the attribute information is reconstructed and output. In this way, the decoding device uses the left-shifted scale value to perform inverse quantization, and uses the left-shifted data to perform decoding using the LoD scheme or the RAHT scheme. This makes it possible to implement calculation having a precision of 1 or less (decimal calculation) in fixed-point operations in inverse quantization and decoding (inverse transform), thereby improving the calculation accuracy.

### Quantization Process in Encoding Device

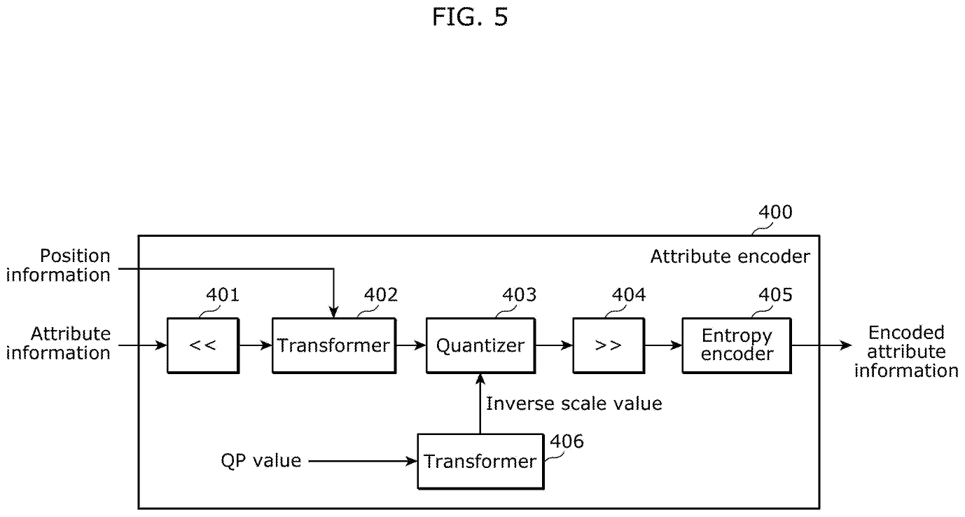

Hereinafter, a quantization process in the encoding device will be described. FIG. 5 is a block diagram of attribute encoder 400 included in the encoding device. For example, attribute encoder 400 corresponds to first attribute encoder 101 or second attribute encoder 102 illustrated in FIG. 1. Attribute encoder 400 includes left bit shifter 401, transformer 402, quantizer 403, right bit shifter 404, entropy encoder 405, and transformer 406.

As with the case of the decoding device, the encoding device performs quantization using (Equation 8) and (Equation 9) below in order to perform fixed-point operations and shift operations.

$$( 1 / scale value ≪ left - shift parameter ) = EncQPtable ( QP \% 6 ) ≫ ( QP / 6 ) \qquad ( Equation 8 )$$

$$Quantized data = data \times ( 1 / scale value ≪ left - shift parameter ) ≫ left - shift parameter \qquad ( Equation 9 )$$

Transformer 406 derives a left-shifted inverse scale value (EncQPtable (QP % 6)) from the QP value using the quantization table. It should be noted that the inverse scale value refers to the reciprocal of the scale value.

Left bit shifter 401 generates left-shifted attribute information by shifting the attribute information to the left. For example, left bit shifter 401 multiplies the attribute information by the left-shift parameter.

Transformer 402 generates left-shifted data by transforming the left-shifted attribute information using the position information. In other words, transformer 402 performs encoding using the LoD scheme or the RAHT scheme.

Quantizer 403 generates left-shifted quantized data by quantizing the left-shifted data using the left-shifted inverse scale value. For example, quantizer 403 multiplies the left-shifted data by the left-shifted inverse scale value.

Right bit shifter 404 generates quantized data by shifting the left-shifted quantized data to the right. For example, right bit shifter 404 divides the left-shifted quantized data by the left-shift parameter. Entropy encoder 405 generates encoded attribute information by entropy-encoding the quantized data. For example, entropy encoder 405 generates binary data by binarizing the quantized data, and generates encoded attribute information by arithmetic-encoding the binary data using contexts.

Here, the quantization table for deriving the left-shifted inverse scale value, for use in transformer 406, is derived using (Equation 10) below from an output of the quantization table for use in the decoding device and a left-shift parameter for use in the encoding device.

$$Output of quantization table of encoding device \times output of quantization table of decoding device \approx {2}^{left - shift parameter in encoding device} \qquad ( Equation 10 )$$

Here, the left-shift parameter in the encoding device is a parameter for determining the calculation performance of quantization. By using a large value for this parameter, it is possible to more accurately quantize the data to be quantized.

For example, when the bit width of the value of the attribute information to be encoded is large, the range of values to be quantized also tends to be large. In such a case, by using a large value for the parameter, quantization and attribute encoding can be accurately performed on any value to be quantized in the large range.

For example, in the G-PCC standard, when the bit width of the attribute information to be encoded is 8 bits, the left-shift parameter is 26. In this case, when attribute information having a bit width exceeding 8 bits is input, by using a left-shift parameter exceeding 26, it may be possible to implement accurate quantization.

For example, when the bit width of the attribute information is 9 bits, which is 1 bit larger than 8 bits, the encoding device may use 27 bits, which is 1 bit larger than 26, as the parameter. Moreover, for example, when the maximum number of bits of attribute information defined in the G-PCC standard is 16 bits, the encoding device may use 26 bits+(16 bits−8 bits)=34 bits.

In some cases, the possible value of the bit width of the data output from transformer 402 is smaller than the bit width of the input attribute information. For example, when transformer 402 outputs an encoding coefficient after transformation or a prediction residual of an attribute value or encoding coefficient, the bit width of the data output from transformer 402 may be smaller than the bit width of the input attribute information. Accordingly, in such a case, the encoding device may reduce the number of bits to be added to the left-shift parameter. For example, when the maximum number of bits of attribute information defined in the standard is 16 bits, instead of adding 8 bits to 26 bits, the number of bits less than 8 bits may be added to 26 bits. In other words, by using a parameter ranging from 27 bits, which is 1 bit larger than 26 bits, to 33 bits, which is 7 bits larger than 26 bits, it may be possible to improve the accuracy of quantization.

In the G-PCC standard, when a 16-bit length value of attribute information is encoded, the left-shift parameter may be 30. It becomes possible to perform accurate quantization and transformation (inverse quantization and inverse transformation) while preventing overflow due to a too large value of the left-shift parameter.

Assuming a case where the maximum value of attribute information defined in the standard is 16 bits, an example of a table in which the left-shift parameter for use in the encoding device is set to 28, 29, 30, 31, or 32 will be described. From (Equation 10) above, (Equation 11) below is obtained.

$$Output of quantization table of encoding device \approx {2}^{left - shift parameter in encoding device} / output of quantization table of decoding device \qquad ( Equation 11 )$$

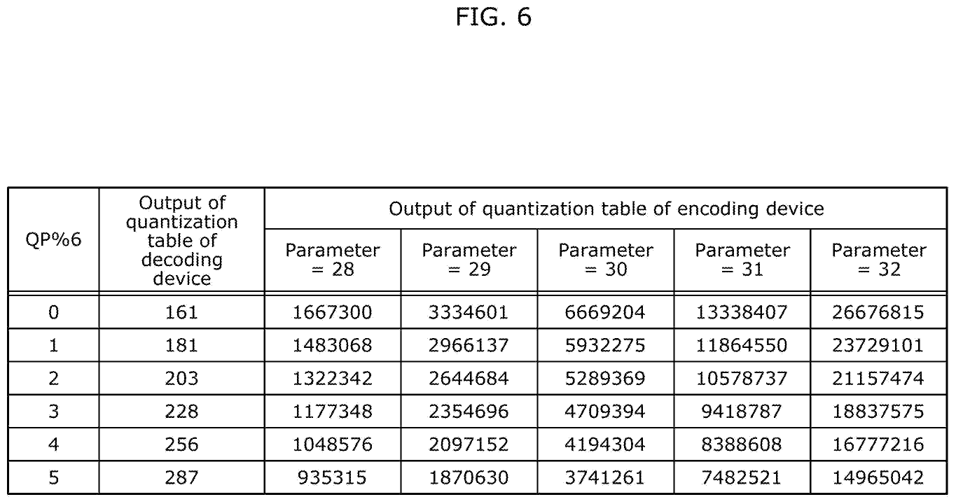

FIG. 6 is a diagram illustrating a correspondence between the output of the quantization table of the decoding device and the output of the quantization table of the encoding device for each of the left-shift parameters in the encoding device. For example, when the output of the quantization table of the decoding device is [161, 181, 203, 228, 256, 287] and the left-shift parameter is 30, the output of the quantization table of the encoding device is [6669204, 5932275, 5289369, 4709394, 4194304, 3741261]. More specifically, when the output of the quantization table of the decoding device is 161, the output of the quantization table of the encoding device is calculated as round (2³⁰/161)=6669204.

When attribute information exceeding 8 bits is encoded using this quantization table, it becomes possible to perform accurate quantization and transformation, thus improving the quality of encoding.

It should be noted that although a case where the maximum value of attribute information is 16 bits has been described here as an example, a similar method can be applied to a case where the maximum value is another number of bits. Moreover, instead of the maximum value of attribute information, the quantization table may be determined based on a value obtained by adding α to the maximum value or a value obtained by subtracting α from the maximum value. It should be noted that α is a given integer. Alternatively, the quantization table may be determined according to the number of bits of the input attribute information or the number of bits of the data to be quantized. Alternatively, the encoding device may include a plurality of quantization tables and adaptively select a quantization table to be used.

### Quantization Process in LoD Scheme

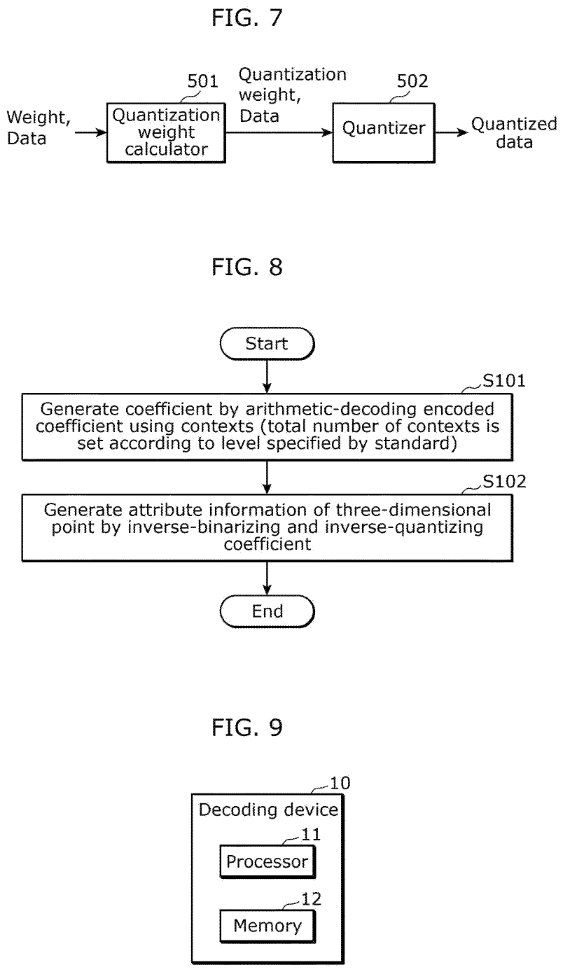

The quantization process in the encoding device in the case where the LoD scheme is used and the process for improving the accuracy of quantization will be described. FIG. 7 is a block diagram illustrating the configuration of a processing unit related to the quantization process included in the encoding device. As illustrated in FIG. 7, the encoding device includes quantization weight calculator 501 and quantizer 502.

First, quantization weight calculator 501 derives a quantization weight for each of points based on the weight output from a transform process. The quantization weight is derived using (Equation 12) below.

$$Quantization weight = weight \times inverse square root of weight \times first right shift \qquad ( Equation 12 )$$

Here, for example, when the number of bits for the first right shift is A, the first right shift refers to division by 2^{A} or A-bit shift down.

Next, quantizer 502 quantizes data using (Equation 13) and (Equation 14) below.

$$Data to be quantized = data \times quantization weight \times second right shift \qquad ( Equation 13 )$$

Here, for example, when the number of bits for the second right shift is B, the second right shift refers to division by 2^{B} or B-bit shift down.

$$Quantized data = data to be quantized / scale value \qquad ( Equation 14 )$$

In other words, the encoding device calculates data to be quantized, by performing the operation of (Equation 13) on the data generated by the transform process. Next, the encoding device generates quantized data by quantizing, using the scale value, the data to be quantized. From (Equation 12) to (Equation 14), the quantized data is represented by (Equation 15) below.

$$Quantized data = data \times ( weight \times inverse square root of weight \times first right shift ) \times second right shift \qquad ( Equation 15 )$$

In this way, the encoding device generates the quantized data by performing the first right shift and the second right shift on the data using the weight to perform A+B bit shift down. Here, when A+B is constant, it is possible to improve the performance of quantization by appropriately setting the ratio of A to B.

For example, when A is increased, the bit width of the quantization weight decreases. Accordingly, the accuracy of the quantization weight may deteriorate. In contrast, when A is decreased, the bit width of data×quantization weight increases due to the increase in the bit width of the quantization weight. Accordingly, the data may be broken since the bit width of data×quantization weight exceeds a predetermined bit width.

For example, in the case of A+B=44, and A=36 and B=8, although there is room in the bit width of data×quantization weight, the accuracy of the quantization weight may be poor due to the decrease in the bit width of the quantization weight caused by the large value of A. In particular, in the G-PCC encoding process, the lower 8 bits of the data output from the transformer are data for use in the transformer, and the bit width required for data×quantization weight is small. When attribute information having a wide bit width exceeding 8 bits is encoded, high accuracy is required for quantization. In such a case, by allocating, to B, part of the number of bits of A, it may be possible to improve the accuracy of the quantization weight without deteriorating the accuracy in the process of deriving the data to be quantized.

For example, by setting A to a value less than 36 and setting B to a value greater than 8, it may be possible to improve the accuracy of quantization. For example, the encoding device additionally allocates 4 bits to B, and uses [A, B]=[32, 12]. Alternatively, the encoding device may additionally allocate 8 bits to B, and use [A, B]=[28, 16]. In this manner, it may be possible to improve the accuracy of quantization. The set of values of A and B may be a combination satisfying A<36 and B>8. For example, A and B are even numbers in terms of the hardware configuration, but may be odd numbers.

As described above, by determining B according to the bit width required for data×quantization weight and allocating the rest to A, it may be possible to improve the accuracy of quantization.

### Context in Entropy Encoding and Decoding

Next, the context of entropy encoding in the encoding device will be described. The encoding device entropy-encodes the quantized data. Specifically, the encoding device generates binary data consisting of a plurality of bits by binarizing the quantized data using exponential Golomb coding. A context is assigned to each of the bits of the binary data. The encoding device arithmetic-encodes each bit using the context. The number of context bits is 1 bit per context, and for example, when the number of contexts is 3, the number of context bits is 3 bits.

Next, the number of contexts in entropy decoding will be described. When data is decoded from the bitstream using entropy decoding, the decoding device assigns contexts to the data using the same method as the encoding device. The number of contexts for use in the decoding device is the same as the number of contexts for use in the encoding device. The decoding device arithmetic-decodes binary exponential Golomb codes from the bitstream using the contexts, and decodes the quantized data by inverse-binarizing and inverse-quantizing the binary exponential Golomb codes.

Hereinafter, a specific example of the number of contexts will be described. For example, when the attribute information is 8 bits, the encoding coefficient or residual component generated in the transform process has a small value, and thus the number of bits of the binary data may also be small. Accordingly, the number of contexts may be 3. In this case, contexts are respectively assigned to bits from the first bit to the third bit, and the same context as the third bit is assigned to the remaining bits from the fourth bit.

In contrast, when the attribute information exceeds 9 bits, the encoding coefficient or residual component may have a large value. In this case, the number of bits of the binary data obtained by binarization using exponential Golomb coding also increases. Accordingly, when the number of values each exceeding 4 bits as the value of the binary data increases, there is a possibility that performance cannot be exhibited since an appropriate context cannot be assigned to each bit. For this reason, it is desirable to set the number of contexts to a value greater than 3. In view of this, the number of contexts may be increased in accordance with the increment of the number of bits of the attribute information.

For example, when the attribute information is 16 bits, the encoding coefficient or residual is likely to have a value less than 16 bits. Accordingly, the number of contexts is set to a value in the range of 4 to 12. In this manner, it may be possible to improve the performance of the entropy encoding and improve the compression ratio. For example, performance improvement can be expected by increasing the number of contexts to 9 to 12. For example, when the number of bits of the attribute information is 16 bits, which is the maximum number of bits of attribute information defined in the G-PCC standard, the number of contexts may be increased to about 3+8=11 in consideration of the maximum number of bits in the standard. Furthermore, it is easy to design as a hardware configuration since 12 is a multiple of 4, and the performance is unlikely to be improved even if the number of contexts is further increased. Accordingly, when the number of bits of the attribute information is 16 bits, which is the maximum number of bits of attribute information defined in the G-PCC standard, it is desirable to set the number of contexts in encoding of the attribute information to 12.

For example, in level specification of the standard, the maximum bit width of the corresponding attribute information may be defined according to the level. This enables hardware design according to the level, and the costs can be reduced. When the maximum bit width of the corresponding attribute information changes according to the level in this manner, contexts of entropy encoding (arithmetic encoding) in encoding of attribute information may be defined according to the level.

For example, when level A supports encoding of attribute information of at most 8 bits, the number of contexts is specified as 3. When level B supports encoding of attribute information of at most 16 bits, the number of contexts may be specified as 12. When data to be encoded is encoded, the encoding device may analyze and estimate the size or distribution of the residual, and set the level based on the result. In other words, the encoding device may set the level regardless of the maximum bit width of the attribute information. Through this level setting, the level or the number of contexts may be changed. It should be noted that a profile may be used instead of the level.

### Summary

As described above, the decoding device (three-dimensional data decoding device) according to the embodiment performs the process illustrated in FIG. 8. The decoding device generates a coefficient (e.g., binary data) by arithmetic-decoding an encoded coefficient (e.g., encoded attribute information) using contexts (S101), and generates attribute information (e.g., an encoding coefficient or decoded attribute information) of a three-dimensional point by inverse-binarizing and inverse-quantizing the coefficient (S102). The total number of contexts is set according to a level specified by a standard.

With this, the encoding device can appropriately set the number of contexts in arithmetic encoding according to the level specified by the standard. Accordingly, the encoding device can improve encoding efficiency. Moreover, the decoding device can appropriately decode the bitstream whose encoding efficiency has been improved in this manner.

For example, the total number of contexts is 3 when the level is a first level, and the total number of contexts is a value in a range of 4 to 12 when the level is a second level. With this, encoding efficiency in arithmetic encoding in the encoding device can be improved.

For example, the standard of the second level is an extended version of the standard of the first level. Alternatively, the standard of the second level has higher functionality than the standard of the first level. Alternatively, the standard of the second level is upwardly compatible with the standard of the first level.

For example, the total number of contexts is 12 when the level is the second level. With this, encoding efficiency in arithmetic encoding in the encoding device can be improved.

FIG. 9 is a block diagram of decoding device 10. For example, decoding device 10 includes processor 11 and memory 12, and processor 11 performs the above processes using memory 12.

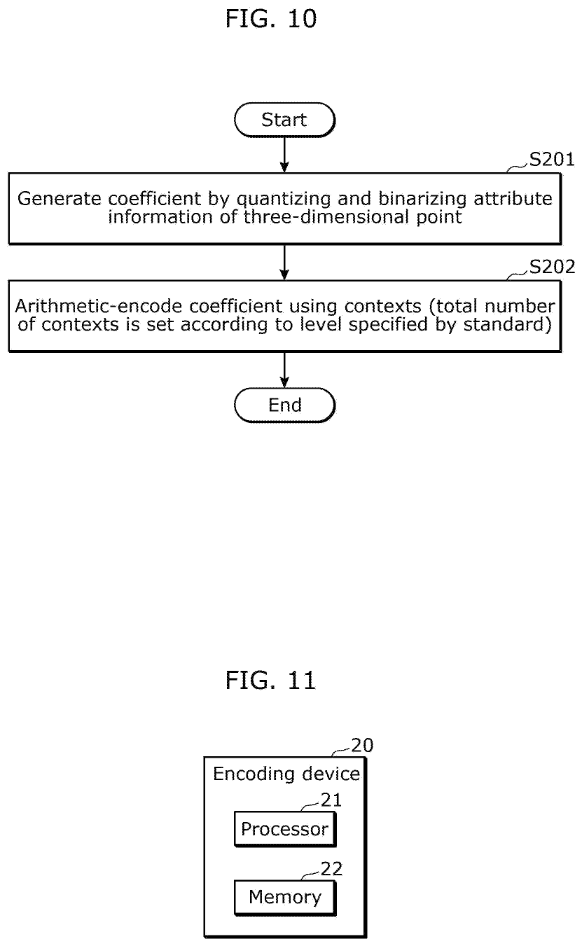

The encoding device (three-dimensional data encoding device) according to the embodiment performs the process illustrated in FIG. 10. The encoding device generates a coefficient (e.g., binary data) by quantizing and binarizing attribute information (e.g., an encoding coefficient or attribute information) of a three-dimensional point (S201), and arithmetic-encodes the coefficient using contexts (S202). The total number of contexts is set according to a level specified by a standard.

With this, the encoding device can appropriately set the number of contexts in arithmetic encoding according to the level specified by the standard. Accordingly, the encoding device can improve encoding efficiency.

For example, the total number of contexts is 3 when the level is a first level, and the total number of contexts is a value in a range of 4 to 12 when the level is a second level. For example, the total number of contexts is 12 when the level is the second level.

FIG. 11 is a block diagram of encoding device 20. For example, encoding device 20 includes processor 21 and memory 22, and processor 21 performs the above processes using memory 22.

The encoding device is an encoding device that transforms and then quantizes attribute information of a three-dimensional point, in which the number of left-shifted bits of the attribute information before the transform is equal to the number of right-shifted bits of the quantized data generated in the quantization, when the attribute information has an 8-bit length, the number of left-shifted bits is 26, and when the attribute information has a 16-bit length, the number of left-shifted bits is greater than 26.

With this, the encoding device can improve the accuracy of transformation by changing the number of left-shifted bits according to the bit length of the attribute information.

For example, when the attribute information has a 16-bit length, the number of left-shifted bits is 30. For example, the quantization is performed according to a first quantization table. When a value of a second quantization table on the decoding side is multiplied by a value of the first quantization table, 2ⁿ is obtained, where n is the number of left-shifted bits. When the second quantization table is {161, 181, 203, 228, 256, 287}, the first quantization table is {6669204, 5932275, 5289369, 4709394, 4194304, 3741261}.

Moreover, the decoding device is a decoding device that inverse-quantizes and then inverse-transforms attribute information of a three-dimensional point, in which the number of left-shifted bits of the attribute information before the inverse quantization is equal to the number of right-shifted bits of the attribute information generated in the inverse transform, when the attribute information has an 8-bit length, the number of left-shifted bits is 26, and when the attribute information has a 16-bit length, the number of left-shifted bits is greater than 26.

For example, when the attribute information has a 16-bit length, the number of left-shifted bits is 30. For example, the inverse quantization is performed according to a first quantization table. When a value of a second quantization table on the encoding side is multiplied by a value of the first quantization table, 2ⁿ is obtained, where n is the number of left-shifted bits. When the first quantization table is {161, 181, 203, 228, 256, 287}, the second quantization table is {6669204, 5932275, 5289369, 4709394, 4194304, 3741261}.

Moreover, the encoding device is a device that quantizes attribute information of the three-dimensional point using a layer to which the three-dimensional point belong, in which first right shift is performed on a weight output from a transform process to calculate a quantization weight, second right shift is performed on the quantization weight and the attribute information to calculate quantized data. When the attribute information has an 8-bit length, the number of first right-shifted bits is 36 and the number of second right-shifted bits is 8, and when the attribute information has a 16-bit length, the number of first right-shifted bits is less than 36, the number of second right-shifted bits is greater than 8, and the sum of the number of first right-shifted bits and the number of second right-shifted bits is 44.

With this, the encoding device can improve the accuracy of transformation by changing the number of right-shifted bits according to the bit length of the attribute information.

For example, when the attribute information has a 16-bit length, the number of first right-shifted bits is 28 and the number of second right-shifted bits is 16.

An encoding device (three-dimensional data encoding device), a decoding device (three-dimensional data decoding device), and the like, according to embodiments of the present disclosure and variations thereof have been described above, but the present disclosure is not limited to these embodiments, etc.

It should be noted that each of the processors included in the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as an encoding method (three-dimensional data encoding method), a decoding method (three-dimensional data decoding method), or the like executed by the encoding device (three-dimensional data encoding device), the decoding device (three-dimensional data decoding device), and the like.

Furthermore, the present disclosure may be implemented as a program for causing a computer, a processor, or a device to execute the above-described encoding method or decoding method. Furthermore, the present disclosure may be implemented as a bitstream generated by the above-described encoding method. Furthermore, the present disclosure as a recording medium on which the program or the bitstream is recorded. For example, the present disclosure may be implemented as a non-transitory computer-readable recording medium on which the program or the bitstream is recorded.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

An encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to an encoding device and a decoding device.

1. A decoding method comprising:
generating a coefficient by arithmetic-decoding an encoded coefficient using contexts; and
generating attribute information of a three-dimensional point by inverse-binarizing and inverse-quantizing the coefficient, wherein
a total number of the contexts is set according to a level specified by a standard.

2. The decoding method according to claim 1, wherein
the total number of the contexts is 3 when the level is a first level, and
the total number of the contexts is a value in a range of 4 to 12 inclusive when the level is a second level.

3. The decoding method according to claim 2, wherein
the total number of the contexts is 12 when the level is the second level.

4. An encoding method comprising:
generating a coefficient by quantizing and binarizing attribute information of a three-dimensional point; and
arithmetic-encoding the coefficient using contexts, wherein
a total number of the contexts is set according to a level specified by a standard.

5. A decoding device comprising:
a processor; and
memory, wherein
using the memory, the processor:
generates a coefficient by arithmetic-decoding an encoded coefficient using contexts; and
generates attribute information of a three-dimensional point by inverse-binarizing and inverse-quantizing the coefficient, and
a total number of the contexts is set according to a level specified by a standard.
